(19) United States
(12) Patent Application Publication
(10) Pub. No.: US 2019/0293587 A1
(43) Pub. Date: Sep. 26, 2019

(54) SCALE SENSORS AND THE USE THEREOF

(71) Applicant: NextStream Sensor LLC, Oklahoma City, OK (US)

(72) Inventors: Jianmin Zhang, Edmond, OK (US); Sam Stroder, Edmond, OK (US); Michael Salerno, Edmond, OK (US)

(73) Assignee: NextStream Sensor, LLC, Oklahoma City, OK (US)

(21) Appl. No.: 15/935,729

(22) Filed: Mar. 26, 2018

(51) Int. Cl. G01N 27/12

(52) U.S. Cl. CPC G01N 27/125

(57) ABSTRACT

A scale sensor comprises sensor electrodes including an uncoated porous metal working electrode and a counter electrode; and an impedance analyzer electrically coupled to the sensor electrodes. A method of monitoring scale deposition comprises placing an uncoated porous metal working electrode and a counter electrode in a fluid to be monitored; and monitoring scale deposition on the uncoated porous metal working electrode using an impedance analyzer electrically coupled to the uncoated porous metal working electrode and the counter electrode.

### BACKGROUND

In petroleum production operations, scales can deposit or accumulate in various locations ranging from the formation to well tubulars and processing equipment, causing a reduction or complete stoppage of production. The accumulation of scales can also lower efficiencies of heat exchangers.

Scale deposition can be mitigated by using scale inhibitors. However, predicting and controlling the type and amount of scale inhibitor to use can be difficult because the amount of scale that will precipitate out of scaling fluids is dependent of fluctuating parameters such as temperature, pressure, water incompatibility and mineral content. More often, to obtain guaranteed performance, operators use scale inhibitors in an amount that is well above the minimum amount required to prevent scale deposition, causing unnecessary material waste. Thus, the art would be receptive to scale sensors that are effective to monitor scale deposition. It would be a further advantage if the scale sensors can monitor scale deposition so that proper scale inhibitors with optimum quantity may be used.

### BRIEF DESCRIPTION

A scale sensor comprises sensor electrodes including an uncoated porous metal working electrode and a counter electrode; and an impedance analyzer electrically coupled to the sensor electrodes.

A scale detecting assembly comprises a connector that is configured to be coupled to a tubular member; an electrode adapter mounted on the connector; and an electrode seal disposed in the electrode adaptor; the electrode seal carrying an uncoated porous metal electrode and a counter electrode.

A flow assembly comprises a tubular member; and a scale detecting assembly as disclosed herein above, wherein the connector is coupled to the tubular member.

A method of monitoring scale deposition comprises placing an uncoated porous metal working electrode and a counter electrode in a fluid to be monitored; and monitoring scale deposition on the uncoated porous metal working electrode using an impedance analyzer electrically coupled to the uncoated porous metal working electrode and the counter electrode.

### BRIEF DESCRIPTION OF THE DRAWINGS

The following descriptions should not be considered limiting in any way. With reference to the accompanying drawings, like elements are numbered alike:

FIG. 1 illustrates an exemplary configuration of electrodes for a scale sensor, where at least one of the electrodes is an uncoated porous metal working electrode;

FIG. 2 is a scanning electron microscope (SEM) image of a sintered porous electrode;

FIG. 3 is an optical microscope image of a 3D printed porous electrode;

FIG. 4 shows exemplary parts that can carry the sensor electrodes; and

FIG. 5 is a cross-sectional view of an exemplary scale detecting assembly according to an embodiment of the disclosure.

### DETAILED DESCRIPTION

Scale sensors that are effective to monitor scale deposition are disclosed. The scale sensors have at least one working electrode with a specific porous structure on which scale generation may be promoted to achieve early scale detection. Specifically, scales can be formed on the porous working electrode before actual scale deposition occurs on the surfaces to be protected. Thus the scale sensors predict the risks of undesirable scale deposition. Responding to the result of such monitoring, a control device can adjust the dosage of scale inhibitors applied to the monitored fluid. Accordingly, the wasteful use of scale inhibitors can be minimized.

The scale sensors described herein have sensor electrodes which include at least one uncoated porous metal working electrode (also referred to as “porous working electrode” or “porous metal electrode” herein), a counter electrode made of a porous or solid metal, and an optional reference electrode. The scale sensors can also have an impedance analyzer electrically coupled to the sensor electrodes.

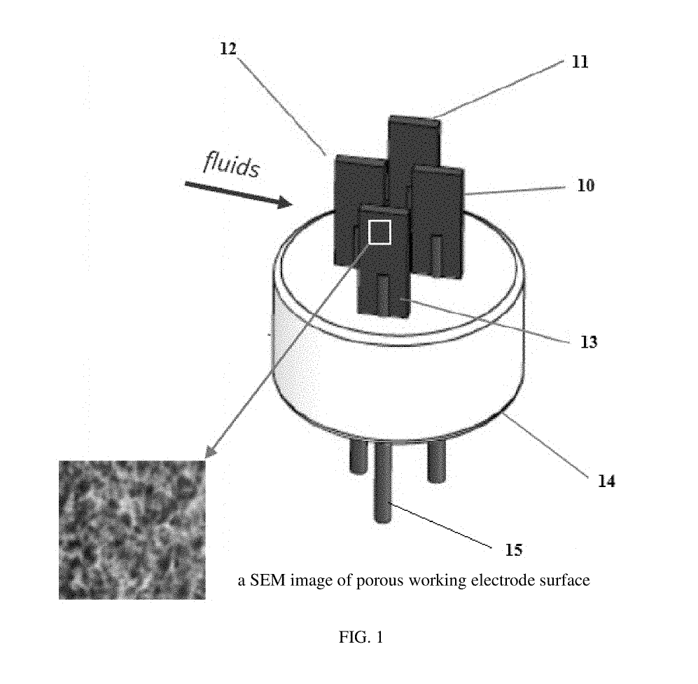

FIG. 1 illustrates an exemplary electrode configuration for a scale sensor. The electrode configuration shown in FIG. 1 includes a porous metal working electrode #1 (13), a porous metal working electrode #2 (11), a counter electrode (10), and a reference electrode (12). The sensor electrodes (10, 11, 12, 13) are mounted on an electrode seal (14). Although working electrodes are designed to promote scale deposition, it is appreciated that the surface around the sensor electrodes, for example, the surface of the electrode seal (14) is covered by an anti-scaling coating. The sensor electrodes are coupled to an impedance analyzer (not shown) via metals, wires, or other means (15).

The porous metal working electrode is uncoated and very durable since it avoids potential issues associated with certain coated or layered electrodes. Meanwhile, the large effective surface area of the porous metal working electrode can facilitate scale deposition and growth, thus achieving early detection of scale deposition.

The porous working electrode can have a pore size of about 10 nanometers to about 100 microns, about 50 nanometers to about 50 microns, or about 200 nanometers to about 1 micron. As used herein, a pore size refers to the largest dimension of a pore and can be determined by high resolution electron or atomic force microscope technology. Different pore sizes can be designed to attract different scales. The porosity of the porous working electrode is about 5% to about 50% or about 10% to about 40%. The porous working electrode can have an effective surface area ratio versus a smooth surface of about 1:1 to about 10:1 or about 2:1 to about 4:1. The thickness of the porous working electrodes is not particularly limited and can be about 0.5 mm to about 10 mm or about 2 mm to about 5 mm.

The material for the porous working electrode is a corrosion resistant alloy. Exemplary alloys include steel, nickel-chromium based alloys such as INCONEL, and nickel-copper based alloys such as MONEL alloys. The steel can be a stainless steel including nickel based stainless steels such as HASTELLOY. As used herein, the term “metal-based alloy” means a metal alloy wherein the weight percentage of the specified metal in the alloy is greater than the weight percentage of any other component of the alloy, based on the total weight of the alloy.

The porous working electrode can have a rod shape with round or square or any other cross-sections. The porous metal electrode can also be a flat plate with a square or rectangular or round surface. When the electrodes have a flat plate geometry, it is preferred that the electrode surfaces are generally parallel to the direction of the fluid flow.

In some embodiments, the scale sensors have two porous metal working electrodes. When two porous working electrodes are used in one scale sensor, different porosities and/or pore sizes can be chosen for each working electrode so that each working electrode attracts different scales in the monitored fluid. Alternatively, when two porous working electrodes are used in a scale sensor, both working electrodes can have the same porosity and average pore size. For example, the two porous working electrodes can be the same. In this instance, the two porous working electrodes can operate alternatingly. For example, a first porous working electrode can be in a self-cleaning mode while a second porous working electrode is in a service mode, then the first working electrode can be switched to a service mode when the second working electrode turns into a self-cleaning mode.

Electrode cleaning of a scaled surface is possible by applying a high current density to the electrode that has the effect of generating gas bubbles that disrupt and remove the scale from the electrode surface. Cleaned electrode surface can be used for accurate monitoring again.

The porous metal working electrode can be manufactured by an additive manufacturing process (also referred to as “3D printing”). The term additive manufacturing as used herein involves building an electrode layer-by-layer. In some embodiments, this can occur by depositing a sequence of layers on a worktable. These deposited layers are fused together using an energy beam from an energy source. The process is then repeated to form a porous electrode.

Any additive manufacturing process can be used herein, provided that the process allows the depositing of at least one layer of a corrosion resistant metal alloy powder upon a worktable, fusing the metal alloy powder to form a fused layer, and repeating these operations until a porous electrode is made.

In an embodiment, metal alloy powders are deposited on a worktable; and fused according to a preset pattern to additively form a porous electrode having a predetermined pore size, porosity, pore distribution, and other desired configuration. The depositing and the fusing can be carried out as part of a selective laser sintering process or a direct metal deposition process. An optical microscope image of a 3D printed exemplary porous electrode is shown in FIG. 3.

The porous metal working electrode can also be manufactured from sintered porous metal sheets of corrosion resistant alloys. In particular, metal powders can be pressed, then sintered via a heat treatment. During sintering, neck growth occurs between metal powder particles, and the metal powder particles mechanically and/or metallurgically combine with each other forming a porous electrode. The means of heating is not particularly limited. Exemplary heating methods include direct current (DC) heating, induction heating, microwave heating, and spark plasma sintering (SPS). In an embodiment, the heating is conducted via DC heating. For example, the pressed metal powders (e.g. in the form of a layer or plate) can be charged with a current, which flows through the pressed metal powders generating heat very quickly. The sintering can be conducted at atmospheric pressure or at a pressure of about 100 psi to about 5,000 psi or about 200 psi to about 3000 psi.

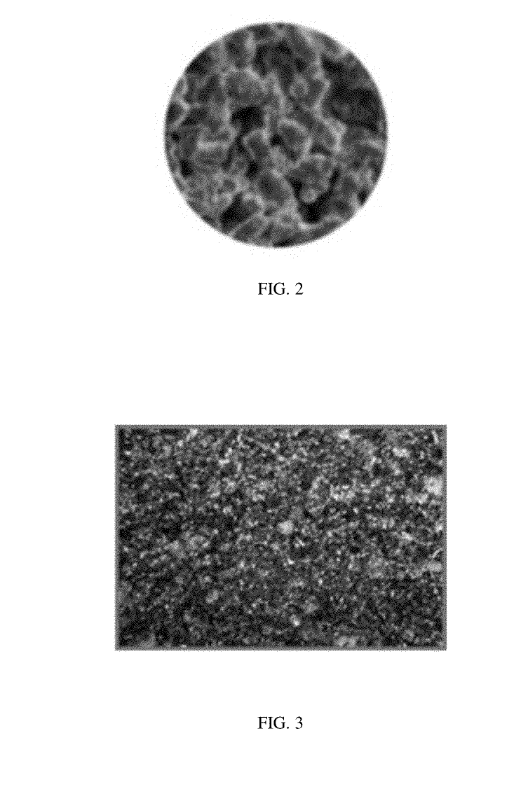

The pore size and/or porosity of the porous working electrode can be controlled by adjusting the process parameters such as the pressure to press the metal powders, and the sintering temperature and pressure. The pore size and/or porosity can also be controlled by adjusting the particle size of the metal powder or using a combination of metal powders having different particle sizes. A scanning electron microscope (SEM) image of a sintered exemplary porous electrode is shown in FIG. 2.

The sensor electrodes can be integrated into a scale detecting assembly. A scale detecting assembly comprises a connector that is configured to be coupled to a tubular member; an electrode adapter mounted on the connector; and an electrode seal disposed in the electrode adaptor; the electrode seal carrying the sensor electrodes.

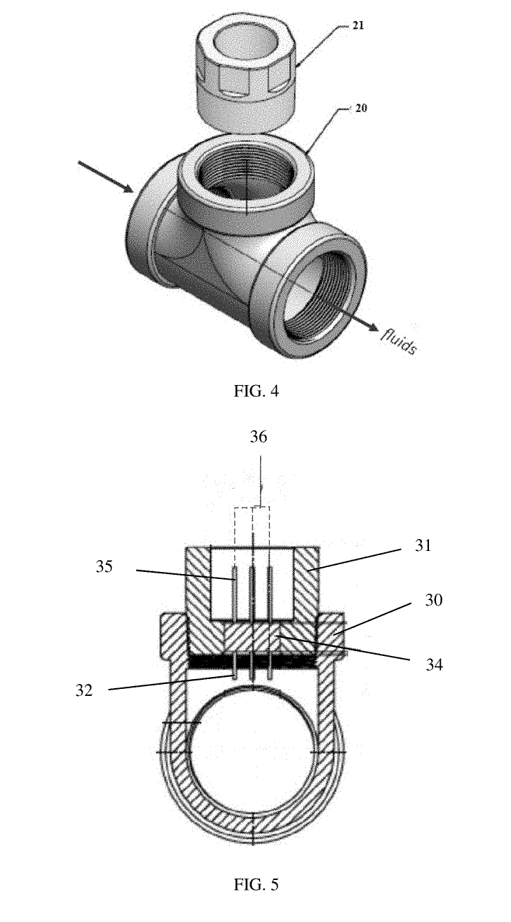

FIG. 4 shows exemplary parts that can carry the sensor electrodes. The exemplary parts include a connector (20), which can be readily incorporated into a tubing or pipe, and a sensor adaptor (21), which can accommodate the electrode seal that carries the sensor electrodes.

FIG. 5 is a cross-sectional view of a scale detecting assembly. The scale detecting assembly includes a connector (30), a sensor adaptor (31) mounted on the connector (30), and an electrode seal (34) disposed in the sensor adaptor (31). The electrode seal (34) carries electrodes (32), which can be coupled to an impedance analyzer (36) via metals, wires, or other means (35).

The scale detecting assembly can further include an impedance analyzer electrically coupled to the uncoated porous metal electrode and a counter electrode, and a control device coupled to the impedance analyzer, wherein the control device is effective to control a dosage of a scale inhibitor applied to a fluid.

Also disclosed is a flow assembly comprising a tubular member; and a scale detecting assembly as disclosed herein, wherein the connector is coupled to the tubular member.

In use, the impedance analyzer sends an exciting sinusoidal voltage input to the sensor electrodes at a preset frequency. The exciting sinusoidal voltage input generates electrochemical impedance outputs that correlate to scaling risks in the monitored fluid. Scaling risks can be determined based on the amount of the scales deposited and/or the rate of scale deposition on the porous working electrodes. Exemplary precipitates that can be detected include CaCO₃, BaSO₄, CaSO₄, SrSO₄, KCl, silica, iron sulfide, hydrates, as well as others that may be encountered in petroleum production applications. Scaling risks can be monitored based on all scale species or a specific scale species, if desired.

The scale sensors disclosed herein can be used in various applications. In an embodiment, the scale sensors are deployed in a fluid to be monitored, such as a fluid found in petroleum producing facilities including, but are not limited to, fluids in well pipelines, produced water, and the like.

A method of monitoring scale deposition comprises placing an uncoated porous metal working electrode and a counter electrode in a fluid to be monitored; and monitoring scale deposition on the uncoated porous metal working electrode using an impedance analyzer electrically coupled to the uncoated porous metal working electrode and the counter electrode. Depending on the result obtained from monitoring scale deposition on the uncoated porous metal working electrode, a dosage of the scale inhibitor can be adjusted if necessary, which includes increasing the dosage or reducing the dosage. Adjusting the dosage of the scale inhibitor can include changing a speed setting of a scale inhibitor injection pump. In addition, by using more than one porous working electrodes having different pore size, porosity, or pore distribution to attract different scales, the scale sensors may also monitor the scaling risk associated with specific scales. Thus, depending on the feedback from the scale sensors, different and/or additional scale inhibitors can be used to maximize the efficiency of the inhibitors.

Set forth below are various embodiments of the disclosure.

Embodiment 1. A scale sensor comprising: sensor electrodes including an uncoated porous metal working electrode and a counter electrode; and an impedance analyzer electrically coupled to the sensor electrodes.

Embodiment 2. The scale sensor of as in any prior embodiment, wherein the uncoated porous metal working electrode has a pore size of about 10 nanometers to about 100 microns, and a porosity of about 5% to about 50%.

Embodiment 3. The scale sensor as in any prior embodiment, wherein the uncoated porous metal working electrode has an effective surface area ratio versus a smooth surface of about 1:1 to about 10:1.

Embodiment 4. The scale sensor as in any prior embodiment, wherein the uncoated porous metal working electrode has a thickness of about 0.5 mm to about 10 mm.

Embodiment 5. The scale sensor as in any prior embodiment, further comprising a second working electrode, wherein the second working electrode has at least an average pore size or a porosity different from that of the uncoated porous metal working electrode.

Embodiment 6. The scale sensor as in any prior embodiment, further comprising a second working electrode, wherein the second working electrode is the same as the uncoated porous metal working electrode.

Embodiment 7. The scale sensor as in any prior embodiment, wherein the second working electrode and the uncoated porous metal working electrode are configured such that the second working electrode and the uncoated porous metal working electrode work alternatingly.

Embodiment 8. The scale sensor as in any prior embodiment further comprising a reference electrode.

Embodiment 9. A scale detecting assembly comprising: a connector that is configured to be coupled to a tubular member; an electrode adapter mounted on the connector; and an electrode seal disposed in the electrode adaptor; the electrode seal carrying an uncoated porous metal electrode and a counter electrode.

Embodiment 10. The scale detecting assembly as in any prior embodiment, further comprising an impedance analyzer electrically coupled to the uncoated porous metal electrode and the counter electrode.

Embodiment 11. The scale detecting assembly as in any prior embodiment, further comprising a control device coupled to the impedance analyzer, wherein the control device is effective to control a dosage of a scale inhibitor applied to a monitored fluid.

Embodiment 12. A flow assembly comprising: a tubular member; and a scale detecting assembly as in any prior embodiment, wherein the connector is coupled to the tubular member.

Embodiment 13. A method of monitoring scale deposition, the method comprising: placing an uncoated porous metal working electrode and a counter electrode in a fluid to be monitored; and monitoring scale deposition on the uncoated porous metal working electrode using an impedance analyzer electrically coupled to the uncoated porous metal working electrode and the counter electrode.

Embodiment 14. The method as in any prior embodiment, further comprising adjusting a dosage of a scale inhibitor added to the fluid based on a result obtained from monitoring scale deposition on the uncoated porous metal working electrode.

Embodiment 15. The method as in any prior embodiment, wherein adjusting the dosage of the scale inhibitor comprises changing a speed setting of a scale inhibitor injection pump.

Embodiment 16. The method as in any prior embodiment, wherein the uncoated porous metal working electrode has a pore size of about 10 nanometers to about 100 microns, and a porosity of about 5% to about 50%.

Embodiment 17. The method as in any prior embodiment, further comprising placing a second working electrode in the fluid to be monitored, wherein the second working electrode is the same as the uncoated porous metal working electrode, and the uncoated porous metal working electrode and the second working electrode work alternatingly.

Embodiment 18. The method as in any prior embodiment, wherein the second working electrode and the porous working electrode have a different average pore size, a different porosity, or a combination thereof to attract different scale species in the fluid.

Embodiment 19. The method as in any prior embodiment, further comprising choosing a scale inhibitor based on a feedback about the scale species in the monitored fluid.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity).

What is claimed is:

1. A scale sensor comprising:
sensor electrodes including an uncoated porous metal working electrode and a counter electrode; and
an impedance analyzer electrically coupled to the sensor electrodes.

2. The scale sensor of claim 1, wherein the uncoated porous metal working electrode has a pore size of about 10 nanometers to about 100 microns, and a porosity of about 5% to about 50%.

3. The scale sensor of claim 1, wherein the uncoated porous metal working electrode has an effective surface area ratio versus a smooth surface of about 1:1 to about 10:1.

4. The scale sensor of claim 1, wherein the uncoated porous metal working electrode has a thickness of about 0.5 mm to about 10 mm.

5. The scale sensor of claim 1, further comprising a second working electrode, wherein the second working electrode has at least an average pore size or a porosity different from that of the uncoated porous metal working electrode.

6. The scale sensor of claim 1, further comprising a second working electrode, wherein the second working electrode is the same as the uncoated porous metal working electrode.

7. The scale sensor of claim 6, wherein the second working electrode and the uncoated porous metal working electrode are configured such that the second working electrode and the uncoated porous metal working electrode work alternatingly.

8. The scale sensor of claim 1 further comprising a reference electrode.

9. A scale detecting assembly comprising:
a connector that is configured to be coupled to a tubular member;
an electrode adapter mounted on the connector; and
an electrode seal disposed in the electrode adaptor; the electrode seal carrying an uncoated porous metal electrode and a counter electrode.

10. The scale detecting assembly of claim 9, further comprising an impedance analyzer electrically coupled to the uncoated porous metal electrode and the counter electrode.

11. The scale detecting assembly of claim 10, further comprising a control device coupled to the impedance analyzer, wherein the control device is effective to control a dosage of a scale inhibitor applied to a monitored fluid.

12. A flow assembly comprising:
a tubular member; and
a scale detecting assembly of claim 9, wherein the connector is coupled to the tubular member.

13. A method of monitoring scale deposition, the method comprising:
placing an uncoated porous metal working electrode and a counter electrode in a fluid to be monitored; and
monitoring scale deposition on the uncoated porous metal working electrode using an impedance analyzer electrically coupled to the uncoated porous metal working electrode and the counter electrode.

14. The method of claim 13, further comprising adjusting a dosage of a scale inhibitor added to the fluid based on a result obtained from monitoring scale deposition on the uncoated porous metal working electrode.

15. The method of claim 14, wherein adjusting the dosage of the scale inhibitor comprises changing a speed setting of a scale inhibitor injection pump.

16. The method of claim 13, wherein the uncoated porous metal working electrode has a pore size of about 10 nanometers to about 100 microns, and a porosity of about 5% to about 50%.

17. The method of claim 13, further comprising placing a second working electrode in the fluid to be monitored, wherein the second working electrode is the same as the uncoated porous metal working electrode, and the uncoated porous metal working electrode and the second working electrode work alternatingly.

18. The method of claim 13, wherein the second working electrode and the porous working electrode have a different average pore size, a different porosity, or a combination thereof to attract different scale species in the fluid.

19. The method of claim 18, further comprising choosing a scale inhibitor based on a feedback about the scale species in the monitored fluid.
